(19) United States
(12) Patent Application Publication
(10) Pub. No.: US 2007/0237202 A1
(43) Pub. Date: Oct. 11, 2007

(54) Method for measuring temperature of heat pipe

(75) Inventor: Jia-Hao Li, Sindian City (TW)

Correspondence Address: HDSL, 4331 STEVENS BATTLE LANE, FAIRFAX, VA, 22033, US

(73) Assignee: JAFFE LIMITED

(21) Appl. No.: 11/399,330

(22) Filed: Apr. 7, 2006

(51) Int. Cl. G01K 1/08

(52) U.S. Cl. 374/147

(57) ABSTRACT

A method for measuring the temperature of a heat pipe includes the steps of: firstly preparing a thermal couple wire formed at one end thereof with a temperature-sensing head, pressing the temperature-sensing head on the surface of the heat pipe to be measured, and a proper amount of a fluid medium is filled between the temperature-sensing head and the surface of the heat pipe. The fluid medium can be water, oil or flowable paste having lower viscosity. Due to the cohesion of the fluid medium, it can fill the gap between the temperature-sensing head and the surface of the heat pipe. As a result, the stability of the thermal contact resistance between the point-contact of the temperature-sensing head and the heat pipe is increased due to the filling of the fluid medium. Also, the contact effect is greatly enhanced to reduce the thermal contact resistance.

### BACKGROUND OF THE INVENTION

1. Field of the Invention

The present invention relates to a method for measuring the temperature of a heat pipe, and in particular to a method for measuring the temperature of a heat pipe capable of increasing the contact with the surface of the heat pipe when measuring the temperature and reducing the thermal contact resistance.

2. Description of Prior Art

After heat pipes are completely manufactured, in order to make sure of the quality of the heat pipes manufactured in mass production, each heat pipe should be measured first the capacity of heat transfer to determine whether the expected performance of heat transfer is achieved. However, since the conventional measuring instruments or apparatuses have some problems, such as high in price, complicated in operation and time-consuming in measurement. For example, a thermal couple wire is adhered on the surface of the heat pipe by adhesive tapes. Such a measuring method cannot be applied to all the heat pipes manufactured in mass production, and only some of them can be sampled and measured. After the sampling measurement of the heat pipes manufactured in mass production, the measured results are calculated to determine whether those heat pipes have conformed to the standard, thereby to control the quality of the heat pipes.

As shown in FIG. 1, it shows a simpler conventional method for manufacturing the temperature of the heat pipe. One end of a thermal couple wire 10a is firstly brought into contact with the surface of the heat pipe 1a to be measured. Then, the end of the thermal couple wire 10a is adhered to the surface of the heat pipe 1a by adhesive tapes 11a to achieve a stable contact during the temperature measurement. As a result, the operation of measuring the temperature of the heat pipe can be smoothly performed. After finishing the temperature measurement, the adhesive tapes should be peeled off. Unfortunately, the glue of the adhesive tapes is liable to remain on surface of the heat pipe 1a. As a result, it is necessary to perform a subsequent washing process to remove the residual glue. On the other hand, the heat pipe 1a may be deformed or damaged due to the excessive peeling force, causing the deterioration in the quality of the products. Further, it also makes the temperature measurement more time-consuming.

Taiwan Patent Publication No. M278867 entitled “Clamping tool (I) for measuring temperature of heat pipe” and Taiwan Patent Publication No. M278868 entitled “Clamping tool (II) for measuring temperature of heat pipe” are proposed to solve the above problems. However, in order to further increase the contact effect between the temperature measurement mechanism and the surface of the heat pipe and reducing the thermal contact resistance, the inventor proposes the present invention to overcome the above problems based on his expert experiences and deliberate researches.

### SUMMARY OF THE INVENTION

The present invention is to provide a method for measuring the temperature of a heat pipe. When the thermal couple wire is brought into contact with the surface of the heat pipe, a fluid medium having cohesion, such as water, oil or flowable paste having lower viscosity, is filled therebetween. In this way, when measuring the temperature of the surface of the heat pipe, the stability of the thermal contact resistance can be increased and the thermal contact resistance can be reduced.

The present invention provides a method for measuring the temperature of the heat pipe, comprising the steps of:
(a) preparing a thermal couple wire, one end of the thermal couple wire formed with a temperature-sensing head;
(b) pressing the temperature-sensing head on the surface of the heat pipe to be measured, and a fluid medium having cohesion is filled between the temperature-sensing head and the surface of the heat pipe, thereby to perform the temperature measurement.

Since the fluid medium can be water, oil or flowable paste having lower viscosity and has cohesion, it can fill the gap between the temperature-sensing head and the surface of the heat pipe. As a result, the stability of the thermal contact resistance between the point-contact of the temperature-sensing head and the heat pipe is increased due to the filling of the fluid medium. Also, the contact effect is greatly enhanced to reduce the thermal contact resistance.

### BRIEF DESCRIPTION OF THE DRAWINGS

FIG. 1 is a schematic view showing a thermal couple wire is adhered to the surface of the heat pipe by an adhesive tape in prior art;

FIG. 2 is a schematic view showing the operation of the present invention;

FIG. 3 is a partially enlarged view showing the portion A in FIG. 2; and

FIG. 4 is a schematic view showing the temperature-sensing head of another embodiment of the present invention.

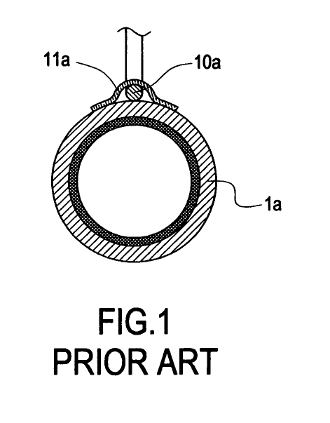

### DETAILED DESCRIPTION OF THE INVENTION

In order to make the Examiner better understand the characteristics and the technical contents of the present invention, a detailed description relating to the present invention will be made with reference to the accompanying drawings. However, it should be understood that the drawings are illustrative but not used to limit the scope of the present invention.

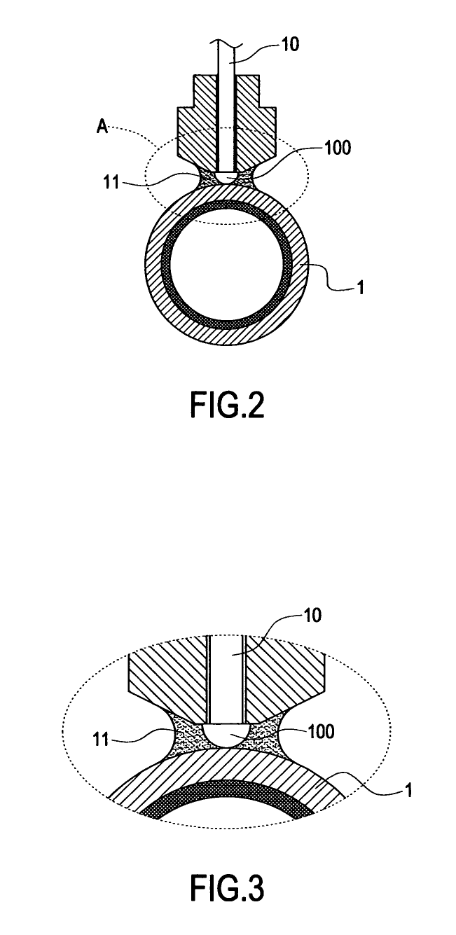

FIG. 2 is a schematic view showing the operation of the present invention, and FIG. 3 is a partially enlarged view showing the portion A in FIG. 2. The present invention provides a method for measuring the temperature of a heat pipe. First, a thermal couple wire 10 is prepared. On end of the thermal couple wire 10 is formed with a temperature-sensing head 100, and the other end thereof is connected to a temperature-sensing device (not shown) for displaying or recording the measured temperature. With the temperature-sensing head 100 of the thermal couple wire 10, the signal of the measured temperature can be transmitted to the temperature-sensing device.

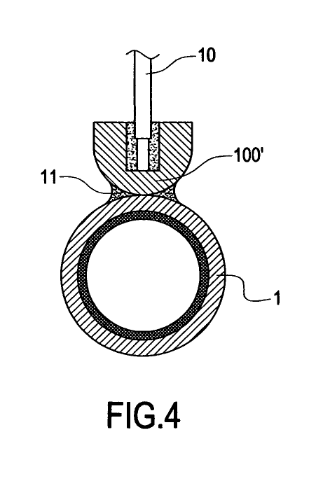

The temperature-sensing head 100 can be formed in the following manner. The bare-wire end of the thermal couple wire 10 is welded and the molten end is naturally solidified to form into a ball-like temperature-sensing head 100 (as shown in FIG. 2). The ball-like temperature-sensing head 100 is able to stably contact the surface of the heat pipe when measuring the temperature. Alternatively, the bare-wire end of the thermal couple wire 10 is directly covered with a heat-conducting material to form a temperature-sensing head 100′ (as shown in FIG. 4).

After finishing the above preparations, as shown in FIGS. 2 and 3, the user can press the temperature-sensing head 100, 100′ on the surface of the heat pipe 1 to be measured. Then, a proper amount of the fluid medium 11 is filled between the temperature-sensing head 100, 100′ and the surface of the heat pipe 1. The fluid medium 11 can be water, oil or flowable paste having lower viscosity. Due to the cohesion of the fluid medium, it can fill the gap between the temperature-sensing head 100, 100′ and the surface of the heat pipe 1. As a result, the stability of the thermal contact resistance between the point-contact of the temperature-sensing head 100, 100′ and the heat pipe 1 is increased due to the filling of the fluid medium 11. Also, the contact effect is greatly enhanced to reduce the thermal contact resistance. Therefore, when the temperature measurement is performed, the measured values can be more accurate. Further, after measurement, it is easy to rinse the fluid medium 11 away, and the washing process will not damage the heat pipe 1. Moreover, it is not necessary to take more time to perform the washing process. As a result, the quality of the heat pipe 1 can be assured and the fast measurement is thus achieved.

Therefore, with the above constitution, the method for measuring the temperature of the heat pipe in accordance with the present invention can be achieved.

According to the present invention, the method for measuring the temperature of the heat pipe can facilitate the temperature measurement by stably contacting the temperature-sensing head 100, 100′ with the heat pipe 1, resulting in a more stable thermal resistance. In addition to measure the temperature more accurately, the washing process will not cause the damage of the heat pipe 1 to produce further difficulty in performing the washing process. Therefore, such method can be applied to measure the heat pipes manufactured in mass production one by one.

According to the above, the present invent indeed achieves the desired effects and overcomes the drawbacks of prior art by employing the above structures. Therefore, the present invention involves the novelty and inventive steps, and conforms to the requirements for an invention patent.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A method for measuring the temperature of a heat pipe, comprising the steps of:
a) preparing a thermal couple wire, one end of the thermal couple wire formed with a temperature-sensing head;
b) pressing the temperature-sensing head on the surface of the heat pipe to be measured, and a fluid medium having cohesion is filled between the temperature-sensing head and the surface of the heat pipe, thereby to perform the temperature measurement.

2. The method for measuring the temperature of a heat pipe according to claim 1, wherein the temperature-sensing head mentioned in the step a) is formed by welding one bare-wire end of the thermal couple wire to melt, so that the molten end is natually solidified to form into a ball-like head.

3. The method for measuring the temperature of a heat pipe according to claim 1, wherein the temperature-sensing head mentioned in the step a) is formed by covering the bare-wire end of the thermal couple wire with a heat-conducting material.

4. The method for measuring the temperature of a heat pipe according to claim 1, wherein fluid medium mentioned in the step b) is water.

5. The method for measuring the temperature of a heat pipe according to claim 1, wherein fluid medium mentioned in the step b) is oil.

6. The method for measuring the temperature of a heat pipe according to claim 1, wherein fluid medium mentioned in the step b) is flowable paste having lower viscosity.
